(19) United States
(12) Patent Application Publication
(10) Pub. No.: US 2026/0330619 A1
(43) Pub. Date: Oct. 22, 2026

(54) PAVEMENT MANAGEMENT SYSTEM USING SATELLITE DATA AND MACHINE LEARNING

(71) Applicant: University of Georgia Research Foundation, Inc., Athens, GA (US)

(72) Inventor: Sung-Hee KIM, Athens, GA (US)

(21) Appl. No.: 19/109,526

(22) PCT Filed: Sep. 6, 2023
(86) PCT No.: PCT/US2023/073509

§ 371 Date: Mar. 6, 2025

Related U.S. Application Data
(60) Provisional application No. 63/403,975, filed on Sep. 6, 2022.

(51) Int. Cl. G06T 7/00; G06N 3/0455; G06N 3/088; G06N 3/09

(52) U.S. Cl. CPC G06T 7/0004; G06N 3/0455; G06N 3/088; G06N 3/09; G06T 2207/10032; G06T 2207/20081; G06T 2207/20084; G06T 2207/30184

(57) ABSTRACT

Various examples are provided related to pavement management for maintenance and rehabilitation of roadways. In one example, a method includes obtaining satellite imagery including a portion of a roadway; determining a reflective value corresponding to the portion of the roadway; determining a pavement condition of the portion of the roadway based at least in part upon the reflective value; and identifying a pavement management strategy based at least in part upon the pavement condition. The pavement condition can be determined based upon pavement surface and subsurface conditions of the portion of the roadway. The pavement condition can be determined by a machine learning model trained using a combination of measured, synthesized and/or feature generated training data.

### CROSS REFERENCE TO RELATED APPLICATIONS

This application claims priority to, and the benefit of, co-pending U.S. provisional application entitled “Pavement Management System Using Satellite Data and Machine Learning” having Ser. No. 63/403,975, filed Sep. 6, 2022, which is hereby incorporated by reference in its entirety.

### BACKGROUND

Pavement condition assessment is commonly performed using information about rideability, structure, surface distress and skid resistance. Pavement condition index (PCI) and Long-Term Pavement Performance Program (LTPP) have been commonly used for pavement monitoring. In spite of their long-lasting contribution, these methods require data collected from in-situ inspection. Due to the extensive road network in the US, these approaches are not capable of monitoring all the roadways.

### SUMMARY

Aspects of the present disclosure are related to pavement management for maintenance and rehabilitation of roadways. In one aspect, among others, a method comprises obtaining satellite imagery including a portion of a roadway; determining a reflective value corresponding to the portion of the roadway; determining a pavement condition of the portion of the roadway based at least in part upon the reflective value; and identifying a pavement management strategy based at least in part upon the pavement condition. In one or more aspects, the pavement condition can be determined based upon pavement surface and subsurface conditions of the portion of the roadway. The pavement condition can be determined by a machine learning model trained using measured and synthesized training data. The machine learning model can be a YOLOR machine learning model. The synthesized training data is generated based upon the measured training data. The synthesized training data can be generated from incorporation of a fault in measured training data. The pavement condition can be determined by a machine learning model trained using synthesized and feature generated training data. The feature generated training data can be generated using variational auto-encoder (VAE) based augmentation with shortcut connections. In various aspects, the pavement condition of the portion of the roadway can be determined based at least in part upon a plurality of reflective values, each reflective value associated with a band of the satellite imagery. The pavement condition of the portion of the roadway can be determined based comparison of the reflective value to a defined threshold and variation of the reflective value over a period of time.

In another aspect, a system comprises a computing device comprising a processor and memory; and an application for pavement condition assessment comprising machine readable instructions stored in the memory that, when executed by the processor, cause the computing device to at least: obtain satellite imagery including a portion of a roadway; determine a reflective value corresponding to the portion of the roadway; determine a pavement condition of the portion of the roadway based at least in part upon the reflective value; and identify a pavement management strategy based at least in part upon the pavement condition. In one or more aspects, the pavement condition can be determined based upon pavement surface and subsurface conditions of the portion of the roadway. The pavement condition can be determined by a machine learning model trained using measured and synthesized training data. The machine learning model can be a YOLOR machine learning model. The synthesized training data is generated based upon the measured training data. The synthesized training data can be generated from incorporation of a fault in measured training data. The pavement condition can be determined by a machine learning model trained using synthesized and feature generated training data. The feature generated training data can be generated using variational auto-encoder (VAE) based augmentation with shortcut connections. In various aspects, the pavement condition of the portion of the roadway can be determined based at least in part upon a plurality of reflective values, each reflective value associated with a band of the satellite imagery. The pavement condition of the portion of the roadway can be determined based comparison of the reflective value to a defined threshold and variation of the reflective value over a period of time.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate examples of pavement sections, in accordance with various embodiments of the present disclosure.

FIGS. 2A and 2B illustrate examples of hyper spectrometer device and satellite imagery results, in accordance with various embodiments of the present disclosure.

FIGS. 3A-3D illustrate an example of field surface measurements using hyperspectral spectroradiometer to evaluate surface conditions, in accordance with various embodiments of the present disclosure.

FIG. 4 illustrates an example of the detection method of the YOLO models, in accordance with various embodiments of the present disclosure.

FIG. 5 illustrates an example of a bounding box, in accordance with various embodiments of the present disclosure.

FIG. 6 illustrates the YOLOR concept with implicit and explicit knowledge-based multi-task learning, in accordance with various embodiments of the present disclosure.

FIG. 7 illustrates a flowchart generation of synthetic images, in accordance with various embodiments of the present disclosure.

FIGS. 8A-8D illustrate processing of images, in accordance with various embodiments of the present disclosure.

FIG. 9 is a flowchart illustrating an example of construct a synthetic dataset, in accordance with various embodiments of the present disclosure.

FIGS. 10A and 10B illustrate an example of construction of a synthetic image, in accordance with various embodiments of the present disclosure.

FIG. 11 illustrates an example of object insertion location decision process for feature placement, in accordance with various embodiments of the present disclosure.

FIG. 12 illustrates an example of normalization of inserted objects, in accordance with various embodiments of the present disclosure.

FIGS. 13A and 13B illustrate an example of the difference between the original and normalized object, in accordance with various embodiments of the present disclosure.

FIG. 14 illustrates an example of a YOLOR learning mosaic, in accordance with various embodiments of the present disclosure.

FIG. 15 illustrates an example of number and location of crack classes after image data generation, in accordance with various embodiments of the present disclosure.

FIG. 16 illustrates examples of training results, in accordance with various embodiments of the present disclosure.

FIG. 17 illustrates an example of example of recognition results, in accordance with various embodiments of the present disclosure.

FIG. 18 illustrates an example of pavement management based upon remote satellite imagery analysis and surface detection, in accordance with various embodiments of the present disclosure.

FIG. 19 illustrates a flowchart generation of synthetic and feature generated images, in accordance with various embodiments of the present disclosure.

FIG. 20 is a table illustrating GPR Scan Image Annotation, in accordance with various embodiments of the present disclosure.

FIG. 21 illustrates an example of a process of generating synthetic data by feature insertion, in accordance with various embodiments of the present disclosure.

FIG. 22 illustrates examples of generated synthetic images, in accordance with various embodiments of the present disclosure.

FIG. 23 illustrates an example of Variational Auto-Encoders (VAE) based augmentation architecture with shortcut connections, in accordance with various embodiments of the present disclosure.

FIG. 24 illustrates examples of generated images by the VAE with different combinations of the connections, in accordance with various embodiments of the present disclosure.

FIG. 25 is a table illustrating data partition for model training, validation and testing, in accordance with various embodiments of the present disclosure.

FIG. 26 illustrates examples of training progress of the YOLOR model, in accordance with various embodiments of the present disclosure.

FIG. 27 illustrates an example of a precision-recall curve, in accordance with various embodiments of the present disclosure.

FIG. 28 is a schematic block diagram of an example of a computing device that can be utilized for pavement condition assessment, in accordance with various embodiments of the present disclosure.

### DETAILED DESCRIPTION

Disclosed herein are various examples related to pavement management for maintenance and rehabilitation of roadways. Remote sensing methods can play a significant role to complement conventional methods. Reference will now be made in detail to the description of the embodiments as illustrated in the drawings, wherein like reference numbers indicate like parts throughout the several views.

### Remote Sensing

To monitor road quality, either as a supplement or as an alternative to the ground-based methods, the application of remote sensing has been investigated. Application of remote sensing in evaluation of road pavement conditions has been recognized by the US national research council. With recent increase of available remote sensing products and accessibility of high-quality methods, remote sensing approach has improved for assessing quality of road infrastructure. The relationship between spectral data obtained from optical imagery and road pavement quality has been identified. Aging and erosion of asphalt pavements result in an increase in reflectance values.

Although Hyperspectral images provide high spectral resolution, spatial resolution is not high enough to prevent mixed pixel issue. Mixed pixel issue occurs when a pixel comprises more than one object. This problem is a common issue when it comes to use optical imagery for road assessment due to the narrow geometry of roads surrounded by other features. To overcome this problem, several studies tried to use images with lower spectral resolution and thus higher spatial resolution. However, capturing pavement distresses using these images with lower spectral resolution is complicated.

Not being affected by mixed pixel issue, Synthetic Aperture Radar (SAR) data can be used for capturing surface roughness. A model was developed based on SAR data to predict International Roughness Index (IRI) of roads. However, due to the high level of noise, the model was not able to predict exact values, rather, it could distinguish between good and bad road with a good overall accuracy. Similarly, IRI values were determined by developing multinomial and binary logit models using Phase Array type L-band SAR (PALSAR) data. The results showed a better performance for the latter model with accuracy of 87% compared to the former model with the accuracy of 61%. Compared to optical imagery, SAR data is more difficult to interpret and its use has not been expanded in road evaluation in spite of its ability to capture information about road quality.

Another solution for the mixed pixel issue is spectral unmixing, which is a technique to evaluate mixture of spectral data obtained from more than one object in a pixel. As mentioned above, mixed pixels are those consisting of more than one object (Objects are called endmembers). The aim of spectral unmixing is to find the endmembers that exist in a given mixed pixel and their respective abundance. Linear unmixing models and nonlinear unmixing models are two main categories for spectral unmixing. The linear models are based on the assumption that there is no interaction between materials and thus no multiple scattering occurs. That being said, nonlinear models assume that such interactions occur and should be considered. consider Nonlinear models have shown more accurate predictions compared to linear models owing to the fact that they real interactions on earth's surface. Neural network nonlinear models can be used to determine endmembers and abundancies in mixed pixels. While providing better performance, nonlinear unmixing models are more complicated to utilize, with linear unmixing models being simpler and effective in many cases.

Regarding road monitoring using satellite images, spectral unmixing can also be as a solution for the mixed pixel issue. Multiple endmember spectral mixture analysis (MESMA) can be performed to overcome mixed pixel issues of satellite images (e.g., from Worldview_2) to map different classes of roads. Spectral unmixing can be used to overcome the main obstacle for use of optical imagery with not very high resolution to monitor road infrastructure.

### Machine Learning

Machine learning has attracted attention in various fields including road infrastructure. To be more specific, road quality monitoring using different remote sensing methods can be enhanced using machine learning methods due to its data-based nature. Machine learning can be classified into two main categories; unsupervised learning and supervised learning. In unsupervised learning, patterns are recognized from unlabeled data for clustering and association application. On the other hand, supervised learning uses labeled data for training models in order to predict outputs. Supervised methods have been used in remote sensing tasks including classification, segmentation, regression, object detection and change detection. In what follows, two main components of supervised learning, shallow learning and deep learning, and their application in road quality evaluation using remote sensing techniques are explored.

Shallow machine learning. Before the advent of deep machine learning methods, shallow machine learning were utilized in remote sensing application aiming at image classification and change detection. The main methods of shallow learning used in remote sensing are Artificial Neural Network (ANN), Support Vector Machine (SVM), and Random Forest (RF), among which RF models were found more useful in pavement monitoring tasks owing to their ensemble nature. However, most of the works were limited to the use of high-resolution imagery obtained from unmanned aerial vehicles. In this regard, a threshold resolution for use of shallow learning models to identify details of roads has been found. By reducing image resolution, models can be evaluated based on their ability to detect potholes and cracks with a resolutions of 3 cm as the threshold resolution.

Deep learning. Deep learning models have become more useful than shallow learning models owing to their reduced demand for feature engineering before training as well as their performance improvement with more data. In semantic segmentation of images like pixel-level segmentation, which are more suitable for remote sensing and pavement monitoring application, fully convolutional network (FCN) facilitated the use of deep learning in this area. FCN has been used for extracting roads from images obtained by remote sensing platforms.

For the resolution needed for road pavement monitoring using remote sensing platforms other than satellites such as digital cameras mounted on vehicles to high resolution images from UAVs have been utilized. For example, pavement distress condition has been evaluated using a dataset consisting of images taken by a digital camera. The automated program classified longitudinal, transverse, and alligator cracking and finally estimated pavement distress severity with an accuracy of about % 90. A supervised methodology based on deep learning can detect cracks of the raw images without the need for preprocessing. In this method, small patches from crack images are extracted as inputs for generating a dataset and training the crack detection model. A deep learning-based crack detection model was developed for concrete pavement, asphalt pavement, and bridge deck cracks. VGG16 net was adopted without the top layer as the encoder and open source pretrained weights were used for the model initiation. An automated model can be used for asphalt pavement crack classification based on machine learning and image processing. Different feature selection scenarios can be utilized to create datasets from digital images. The datasets can then be utilized to train and verify the machine learning algorithms including the random forest (RF), the artificial neural network, and the support vector machine (SVM).

The use of deep learning can assist transportation agencies with a high classification accuracy rate. The application of hyperspectral remote sensing has been investigated for mapping asphalt road condition. Filed hyperspectral data obtained from GER1500 radiometer can be utilized to provide spectral measurements for developing a spectral library for asphalt. Spectral feature analysis indicated that pavement condition is affected by asphalt age, material quality, and road circulation. Based on the results, the following analysis methods can be used for detecting asphalt pavement condition: Principal Component Analysis (PCA), thresholding of color transformation images, unsupervised classification, Iterative Self-organizing Data Analysis (IsoData), supervised classification Spectral Angle Mapper (SAM), and texture measurements using Grey-level Co-occurrence Matrix operator. A pixelwise crack detection architecture has been developed that utilizes convolution, pooling, transpose convolution, and concentration operations and produces yields with a high accuracy and precision. A date-driven framework using artificial neural network, supervised machine learning methods, and smartphone technology has also been developed for the spatial condition-assessment mapping of surface anomalies of pavements.

0.5 m-resolution satellite images have been used to classify roads based on their quality using AlexNet, VGG, and SqueezNet models. IRI data also were collected to train, validate and test the models. According to results, the accuracy of their models was reported as 88% for 2-category classification and 73% for 5-category classification. Road quality was also predicted from Landsat 8 satellite imagery by training a convolutional neural network model. The best models predicted road quality with 70.5% accuracy. It has been indicated that for the goal of road feature detection 3m resolution is the threshold resolution.

YOLO (You Only Look Once) is one of the fastest real time object detection algorithms which has been modified to provide YOLOR (You Only Look One Representation). YOLO is called an object detector as the algorithm finds the location (the boundary box of objects) as well as the class of objects. The algorithm which is based on the latest generation of Deep Neural Network (DNN) algorithms, takes only one single forward propagation through a neural network to detect objects, thus is known for its speed and high accuracy. YOLOR divides the individual input images into an even number of grids. If the center of a detected object falls into a grid cell, that grid cell detects the object. That is, YOLOR predicts bounding boxes, the confidence of those bounding boxes, and their class probabilities at the same time. It can be concluded that YOLOR has advantages over traditional object detection methods as it is extremely fast so that the frames of a streaming video can be processed in real time. Second, YOLOR takes the entire image in the training and testing steps. Thus, it has less background errors. Third, YOLOR learns how to generalize the representations of objects. Thus, the model performs well when applied to new domains inputs.

### Preliminary Field Testing

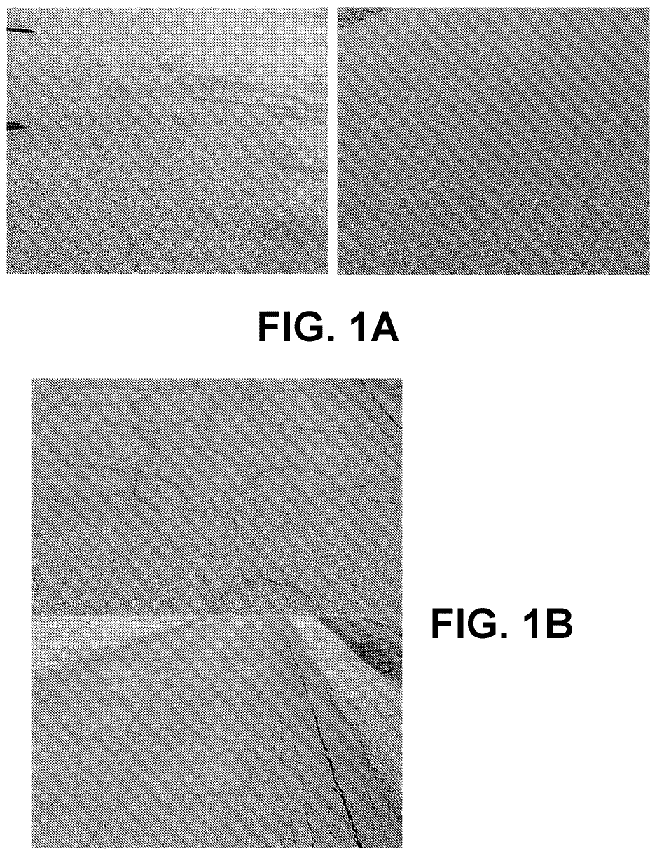

For preliminary evaluation of the feasibility of satellite images to estimate whether a pavement section is aged or not, using a hyper spectrometer device (SuperGer), scans from two road sections were obtained. Images of the first section are shown in FIG. 1A and images of the second section are shown in FIG. 1B. The first section was newer than the second section, which was relatively aged and included many transvers and alligator cracks.

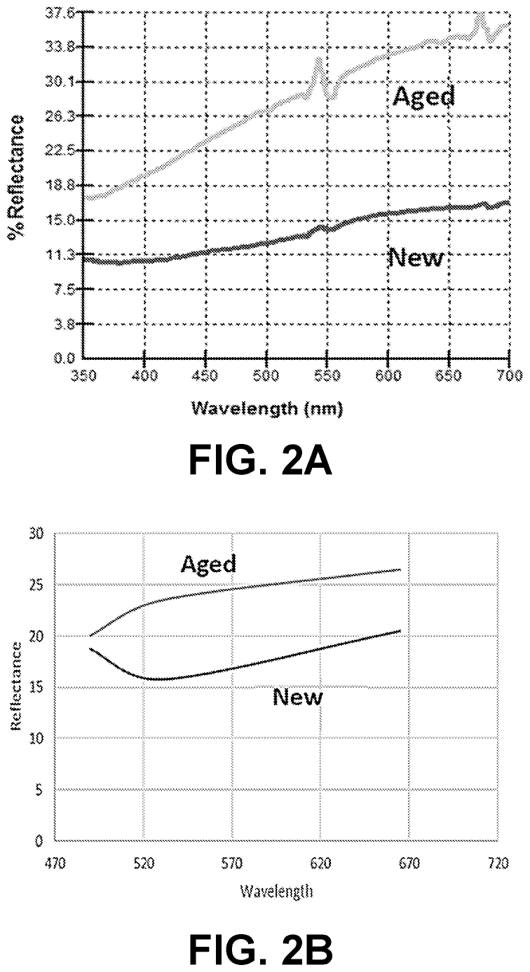

After taking the scans from these sections and recording their GPS coordinates, satellite images from Planet satellite imagery with 3m spatial resolution were obtained. Using SNAP software, the reflectance values of those sections were determined and compared to those of the hyper spectrometer device. FIGS. 2A and 2B illustrate the preliminary data for the hyper spectrometer device and the satellite imagery, respectively. Planet satellite imagery was able to distinguish these 2 sections based on their reflectance values as the relatively new section has lower reflectance than the relatively aged one. This result indicates that the reflectance of the asphalt pavements increases with aging.

Satellite images can be utilized to estimate the cracking potential of pavement surface. Based on the measured % reflectance and wavelength information, the cracking potential of pavement surface can be successfully detected as % reflectance is function of aging. Further, the methodology used in this study can be used for quality control and quality assurance for newly surfaced pavement when the % reflectance data are continuously monitored. The information can be used to save the maintenance and rehabilitation cost for existing and newly constructed pavement.

Pavement deteriorates along with time and traffic. Fatigue cracking, potholes, and rutting are the most common failure types of asphalt pavements. During the early years of the service life, surface asphalt materials lose a large amount of bitumen due to volatilization, absorption, and oxidation with solar radiation, which make the layer to be more brittle and vulnerable with the formation of cracks, rutting, and potholes. When the pavement gets more aged, the combination of traffic, environmental loading, and infiltrated water from rainfall exacerbate the pavement condition.

In terms of the remote sensing, a newly paved asphalt layer exhibits absorption features due to the presence of oily components and uniform surface. When the pavement surface deteriorates by either aging process, by factors like photochemical reaction or influence of heat, the oily components in the asphalt mix decrease causing the reduction of absorption and increase of reflectance in all parts of the wavelength spectrum (See FIGS. 2A and 2B). In addition, cracking, depressions, sink holes and other wear can affect the uniformity of the surface.

Satellite images consist of bands and pixels in which each pixel has a number referred to as Digital Number (DN) or Brightness Value (BV) ranging from 0 to 255. Every material has a specific spectral response that can be used for land use/land cover classification. The brightness values in a remotely sensed image can provide useful information for assessing the present situation. There are numerous satellite platforms each providing a wide range of imagery datasets with various features for different monitoring applications.

### EXAMPLE

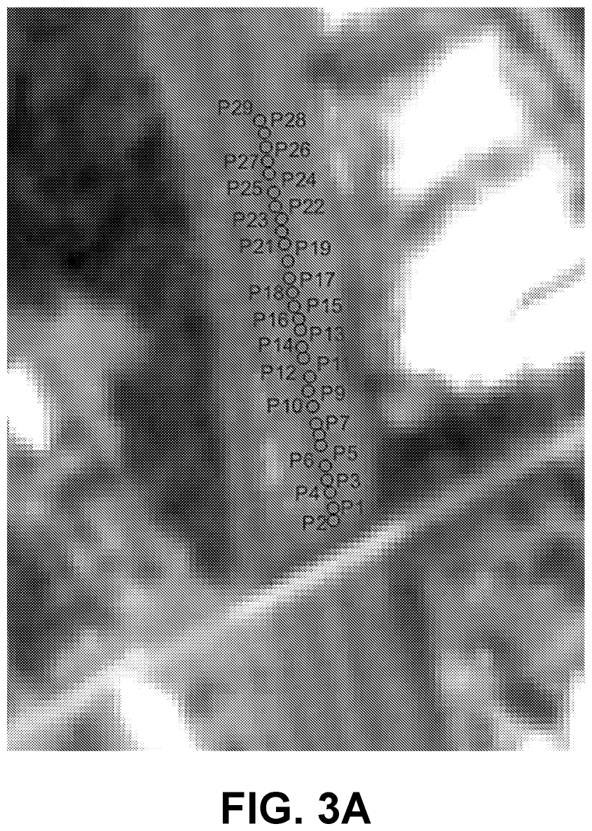

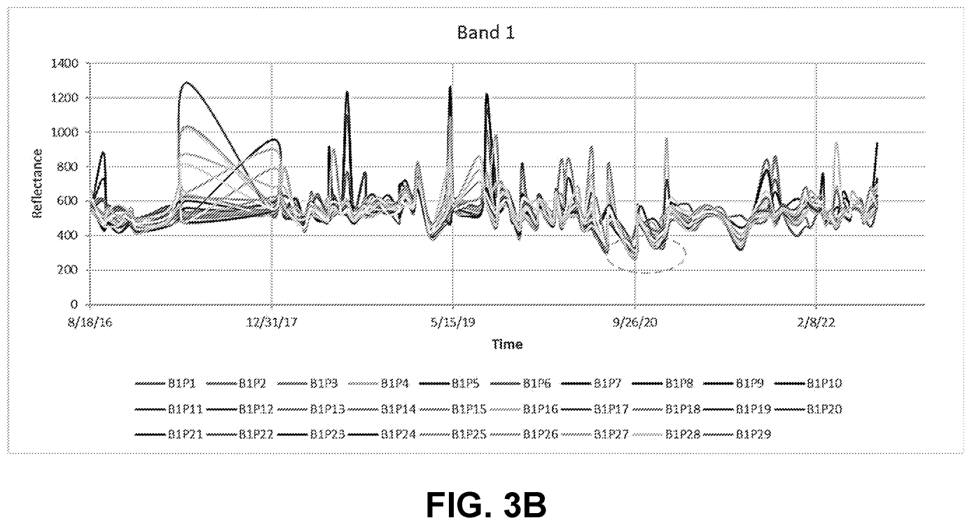

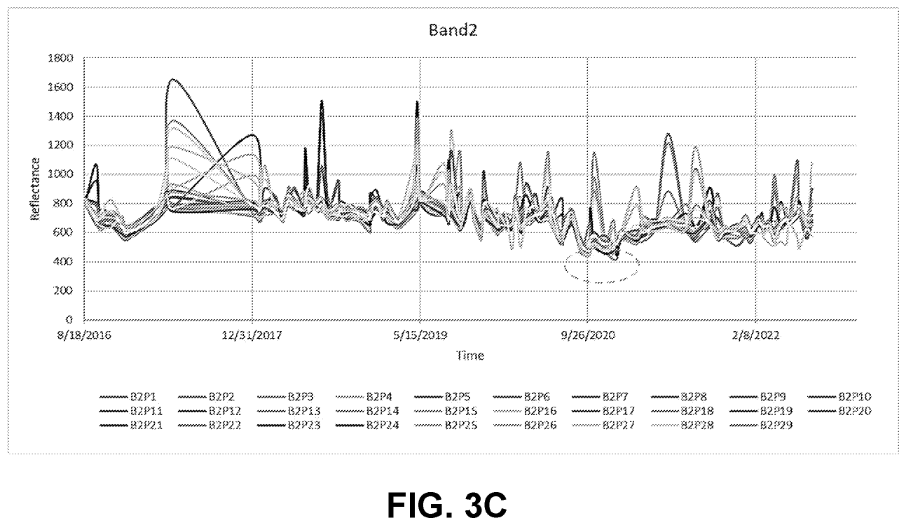

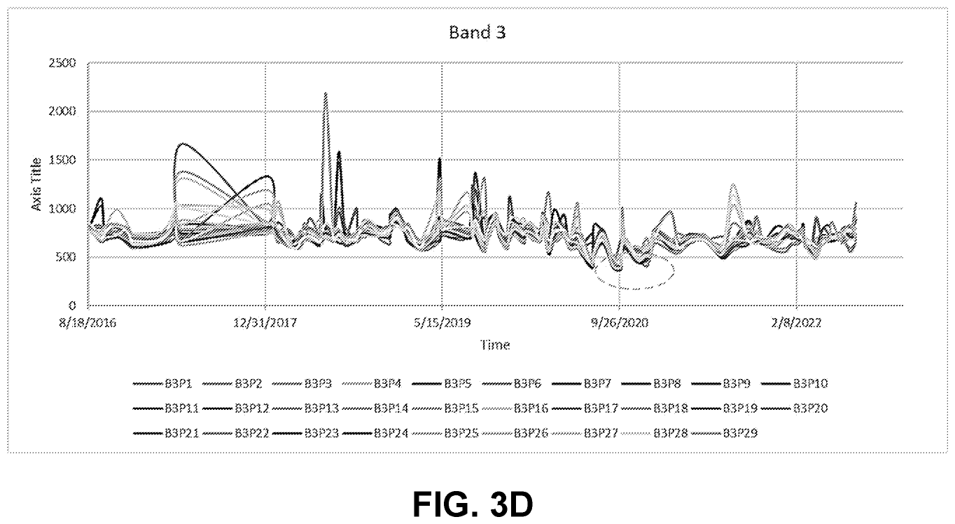

Field surface measurements using hyperspectral spectroradiometer (e.g., Spectra Vista, HR-1024i) on a flexible road section were conducted on 29 different points and the coordinates of each point were recorded. Images of the flexible road section were obtained from “Planet” satellite imagery. FIG. 3A illustrates an example of an image with the different points indicated. The distance of each point (e.g., P1, P2, . . . ) is 20 feet. ArcGIS pro, QGIS and “Profile/Spectral profile” plugins were used to extract reflectance values of the pixels corresponding to the Lat/Long recorded in the field. From 2016 to 2022, 93 images were obtained and reflectance values (for 4 bands) of 29 points were extracted. Total number of data points are 2697 (29 pts*93 images). The bands are band 1 (Blue), band 2(Green), band 3 (Red), and band 4 (NIR). The reflectance values of each point from Aug. 23, 2016 to Jul. 25, 2022 were extracted and the results are shown in FIGS. 3B-3D.

Reflectance values of aged asphalt pavement are higher than those of the new pavements. According to the state department of transportation (DOT) report on this flexible section in October 2019, milling and overlay of the roadway was recommended and the maintenance was done in 2020. As depicted in the images of FIGS. 3B, 3C and 3D (band 1, band 2, and band 3), there is a drop in the reflectance values in 2020. This shows that the decrease in reflectance values may be attributed to a resurfacing of the section that was captured in the satellite images. It should also be mentioned that the spikes in the graphs are because of vehicles in the images.

As show in FIGS. 3B-3D for bands 1 through 3, reflectance values between 2020 and 2021 show the lowest, which indicates the pavement maintenance work (i.e., milling/overlay) was conducted. In another words, this result can be used to identify the reflectance threshold value that requires asphalt milling/overlay to maintain the pavement in good condition. In this specific pavement section, the state DOT confirmed that the subjected pavement section was milled and overlaid in 2020. In turn, the reflectance value that needs maintenance work was identified to be 600 (for Band 2) for this section from this analysis. This maintenance and rehabilitation strategy using satellite imagery is extremely useful avoiding current time-consuming/expensive/labor intensive field condition survey.

### Pavement Subsurface Anomaly Detection

Cracks are surface deterioration caused by various mechanisms occurring in the pavement and their presence indicates structural damage which, in the long run, leads to faster deterioration. Proper assessment of crack progression is certainly helpful in uncovering the source of this type of failure; so is also the correct choice of repair technology. Ground Penetration Radar (GPR) as an auxiliary tool that can be used for assessing the structural condition of pavements in terms of identifying anomalies.

Deep convolutional neural networks (CNNs) have been successfully used in pattern recognition and classification. Compared with conventional NN, the architecture of deep CNN comprises several interlayer integration and integration layers, which is an analog of the receptive field. This architecture has a big advantage in terms of visual representation with some level of abstraction. Deep CNN can improve the target detection accuracy of GPR images and flexible approach. Although deep learning techniques can be applied in GPR data processing, the performance of deep learning models is still a concern in the real-world applications.

A composite dataset for GPR images (synthetic and real) is proposed for use with a YOLOR deep learning model to increase the accuracy and flexibility of target detection from real GPR images. For more flexibility, the original model of the GPR image can be used as an input image without doing any feature extraction first. This can be extended for detection of pavement conditions using satellite imagery.

### Deep Learning Model

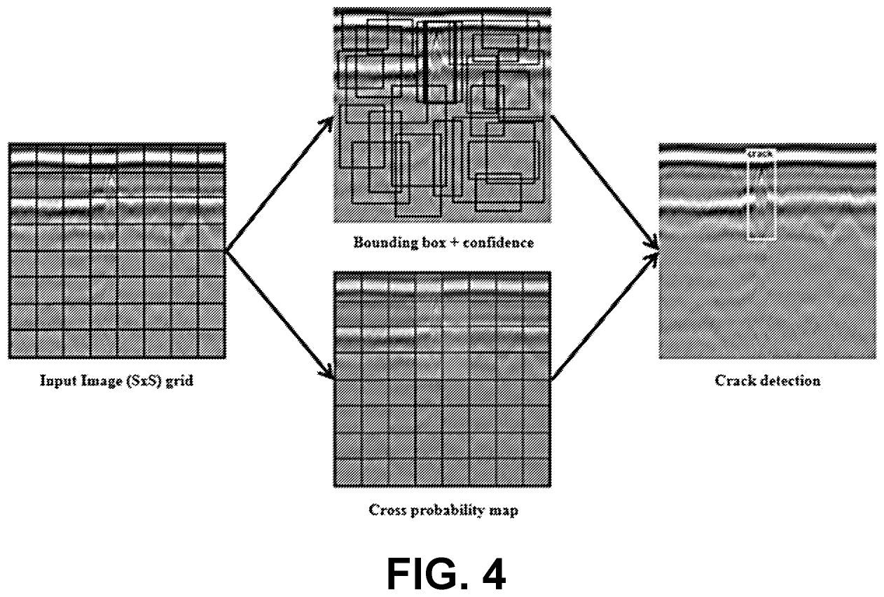

One type of deep learning model is the YOLO family, that uses neural networks to provide real-time object detection. This algorithm provides both speed and accuracy. It has been used in various applications to detect people, parking meters, fruit identification even commercial products recognition. The YOLO algorithm works using the following three techniques: residual blocks, bounding box regression, and intersection over union (IOU). FIG. 4 illustrates an example of the detection method of the YOLO models.

Residual blocks. The first input image is split into S×S grids. Then, a number of bounding boxes with the confidence of these boxes are all predicted and the class probabilities for hidden cracks are also predicted. Therefore, the object detection result is obtained.

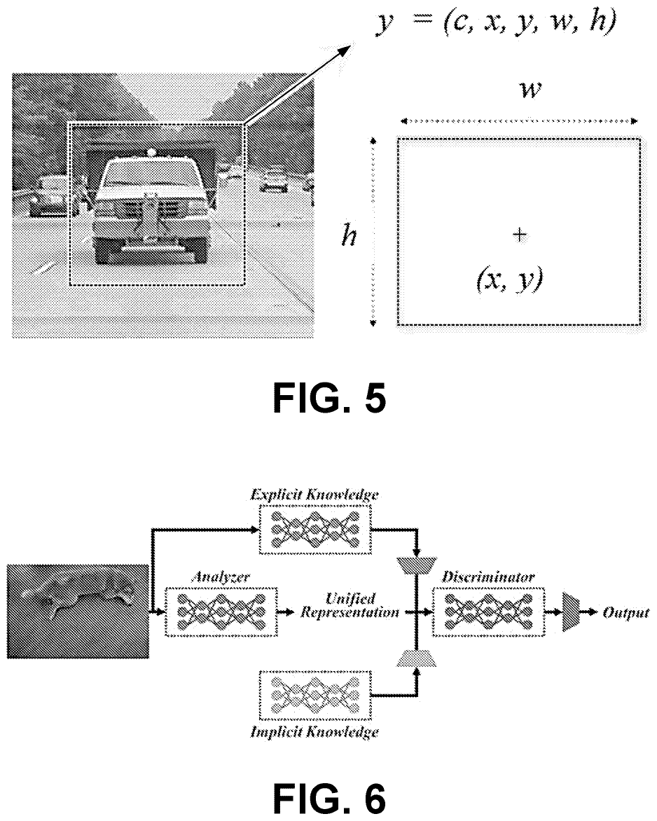

Bounding box regression. A bounding box is a contour that highlights an object in an image. Each bounding box in the image includes the following attributes: class (c) (e.g., person, car, traffic light, etc.), bounding box center (x, y), width (w), and height (h). FIG. 5 shows an example of a bounding box. The bounding box has been represented by an outline. YOLO uses a single bounding box regression to predict class of objects, center, width, and height. The probability of an object appearing in the bounding box of FIG. 5 can be represented.

Intersection over union (IOU). IOU is an object detection phenomenon describing the overlap of boxes. YOLO uses IOU to provide a perfect surrounding output box of objects. Each grid cell is responsible for forecasting its selections and confidence score. The IOU equals 1 if the final predicted box is the same as the actual box. This mechanism removes boxes that are not equal to actual boxes.

YOLOR. YOLOR is a modern machine learning algorithm to detect objects. YOLOR is defined as a “unified network to encode implicit and explicit knowledge together”. Results show the advantages of utilizing tacit knowledge. YOLOR is specially designed to detect objects, instead of other learning cases, such as recognition or analysis. This is because object detection focuses on the common identifiers that make an object belong to a certain category or class. In contrast, other types of machine learning use cases require more precise processes. Object identification utilizes the machine learning model to match the range of variations that will generate objects together.

For example, object analysis is commonly used for medical purposes, where conventional object detection algorithms designed to distinguish between cars and people would be ineffective. Object identification offers advantages for detecting underground features like different types of cracks signatures in subsurface GPR images, and may be extended to identification of pavement conditions from satellite imagery.

Humans can learn and understand the physical world based on sight, hearing, and touch (explicit knowledge)—but also based on experience (implicit knowledge). Thus, humans can efficiently process brand new data using rich variety of previous learning experiences acquired through normal learning and stored in the brain. YOLOR provides an approach to combine explicit knowledge, defined as data-and input-based learning, with implicit knowledge which is learned unconsciously. Thus, the concept of YOLOR is based on coding explicit and implicit knowledge together, in the same way that Human brains process implicit and explicit knowledge combined. The unified network provided in YOLOR creates a unified representation to serve multiple tasks at the same time.

FIG. 6 illustrate the YOLOR concept with implicit and explicit knowledge-based multi-task learning. There are three notable processes by which this architecture is functionally implemented: kernel-space alignment, prediction refinement, and convolutional neural networks (CNNs) with feature learning multitasking. As a result, when tacit knowledge is fed into a neural network that has been trained with explicit knowledge, the network benefits from performing different tasks. The YOLOR algorithm aims to perform tasks using a fraction of the cost of comparative algorithms. Thus, YOLOR is a unified network that can analyze implicit and explicit knowledge together and create a common representation through this methodology. Combined with modern methods, YOLOR achieves object detection accuracy comparable to YOLOv4, with an increased inference speed of 88%. This ranks YOLOR as one of the fastest object detection algorithms in modern computer vision. While for the detection efficiency, On the MS COCO dataset, the mean accuracy of YOLOR was 3.8% higher than that of PP-YOLOv2, at the same inference speed.

Explicit knowledge is fed to the neural network by providing metadata or a database of clear images that are carefully annotated or well organized. Explicit knowledge can be thought of as flashcards for a machine learning model, with clear definitions and corresponding images/inputs to those images. Once the model has gone through the flashcard deck, the model is now fully adept at classifying images with their respective definitions, or “classes”. Explicit knowledge of YOLOR is obtained from the surface layers of the neural network. This knowledge corresponds directly to the observations that are supposed to be made. Although tacit knowledge can help machine learning models perform tasks with YOLOR efficiently. For humans, latent knowledge is developed unconsciously. For neural networks, tacit knowledge is obtained by features in deep layers. Knowledge that does not correspond to observation is also called implicit knowledge.

Dataset. Object detection is a highly recognized topic in the deep learning community, which can be summarized in 2 steps:
Location: Finds an area (bounding box) in the image with an object of interest.
Classifier: Classifies the defined object into one of the predefined classes of model training.
   To create a model, the training data needs to include the image itself and the caption (bounding box) that tells exactly where the objects are. Once a set of training annotated images is available, object detection model building can be performed. Unfortunately, creating an image dataset with bounding boxes can be quite difficult. In general, a set of images is already available, Labelbox or MakeML can be used to define bounding boxes around each object and generate annotations.

Deep learning-based methods utilize a large number of labeled data sets to train the model. Unlike conventional image processing tasks, the labeled GPR dataset is very limited. Since the needed training data is not available, additional GPR data can be collected to extract the features needed to explore or dig deeper into the web. The images can be annotated by hand in preparation for modeling. If multiple GPR scanned sections, team members, and time are available, this approach is consuming but very effective. To generate more images for the deep learning model, more synthetic data can be created based on the collected images from the scanned sections.

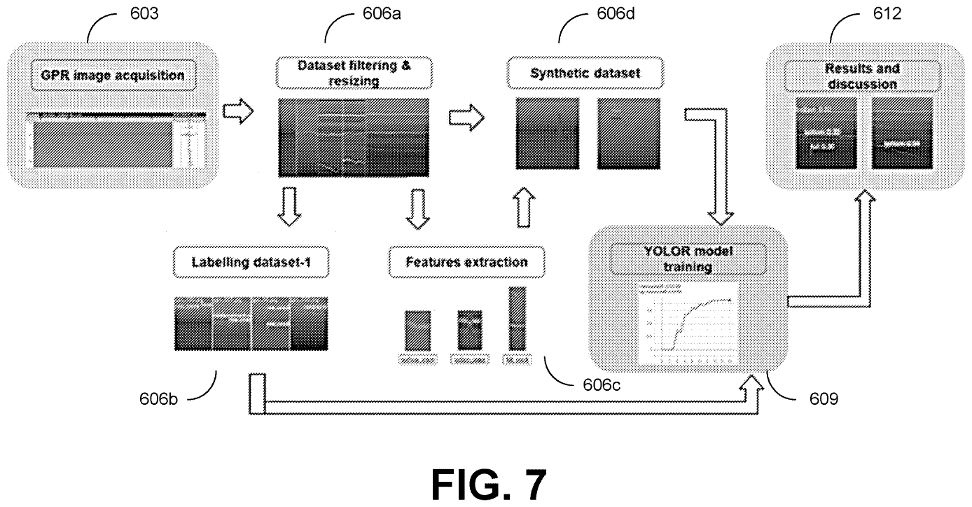

The images collected for this evaluation were collected over different roadways, representing rural, urban, and interstate roadways using a test van. The collected data was managed in two different pipelines as shown in FIG. 7, which illustrates a flowchart of the Al application to the GPR images. The images are classified into two groups, with features and without features. The images without features are used as a blank background for the synthetic dataset creation, while images with distinguished features are labelled for the verification processes during training of YOLOR model.

The flow of work shown in FIG. 7 illustrates how the collected data is handled and analyzed using YOLOR model. First section (603) is GPR image acquisition, which introduces the source of GPR images of the scanned section. The second section is the dataset construction that includes four different processing steps: dataset filtering & resizing (606a), labeling dataset (606b), features extraction (606c), and synthetic dataset (606d). The third section (609) is YOLOR model training, which describes the detection principle and network architecture of the YOLO models. The last section (612) is the results and discussion that mainly analyzes training results and the actual detection results.

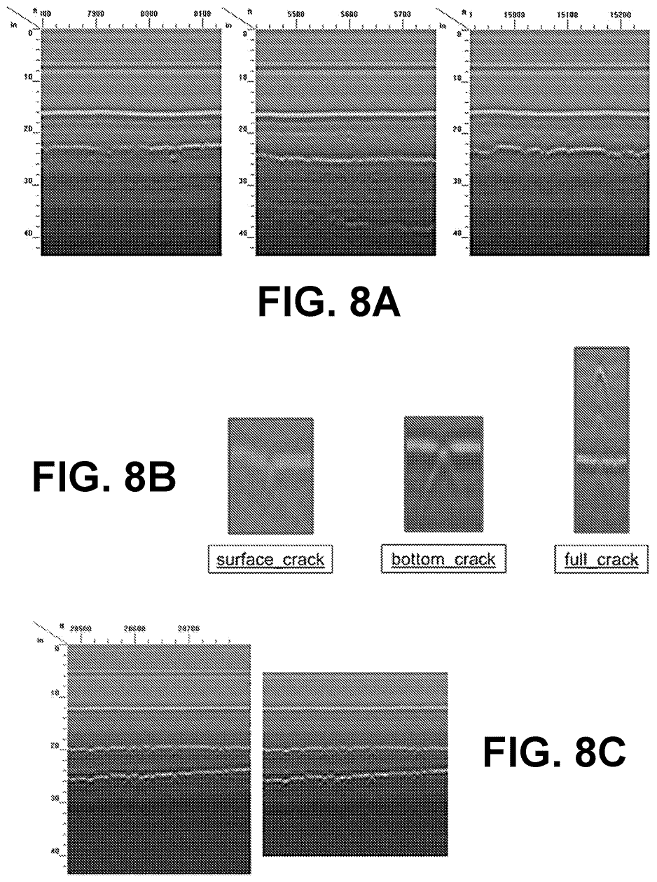

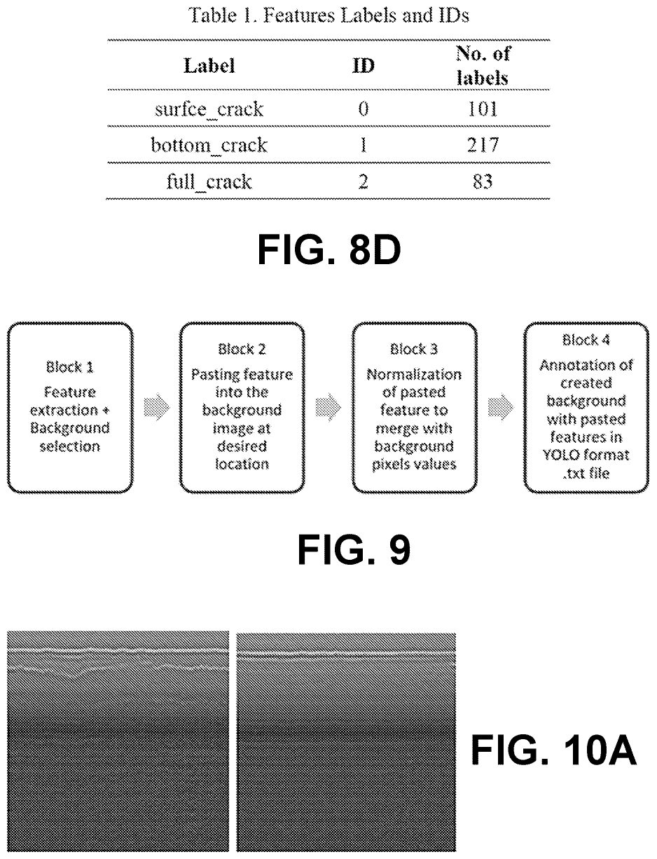

Collected GPR dataset. A total number of 6000 images were collected and extracted from GPR recordings, a first stage refinement helped to extract 400 images with noticeable features. An example of extracted images is shown in FIG. 8A. Subsurface features are unique in their formation, so using object detection in deep learning models; these features' signatured formation shown in FIG. 8B can be extracted from GPR output videos or pictures and applied on further scans. Those extracted features can be used later in the creation of the synthetic dataset.

The extracted frames are minimally processed to use this model in real-time road scanning. Enough cropping can be performed to remove the air coupling effect and subgrade soil beneath the pavement layers that would otherwise be distracting to the application. FIG. 8C shows both raw image and the processed images cropped to 340×340. Once the images have been cropped to the defined zone of interest, the images can be labelled using free online labeling software, e.g., makesense.ai. The images were labelled with all the features within the frame that are relevant to the selected features. A label list is shown in the table of FIG. 8D.

The GPR-labeled images can be used for validation during the YOLOR model training process. However, as shown in the table of FIG. 8D, the collected GPR images do not provide enough information to train well-defined models for subsurface (GPR) identification. For this reason, a synthetic dataset is needed to increase the efficiency of such models.

Synthetic dataset. In the absence of sufficient data, it is impractical to run a deep learning model with such a small dataset for training purposes, so synthetic datasets can be made to meet the training needs. In the model that is used to construct the synthetic dataset, there are four main blocks that can be grouped together to form a model. FIG. 9 is a flowchart summarizing the four blocks and their arrangement. As a general rule, the algorithm involves obtaining the background GPR image, adding the group of feature objects into the frame, adjusting the image in the necessary ways, adding annotations, and finally saving the image.

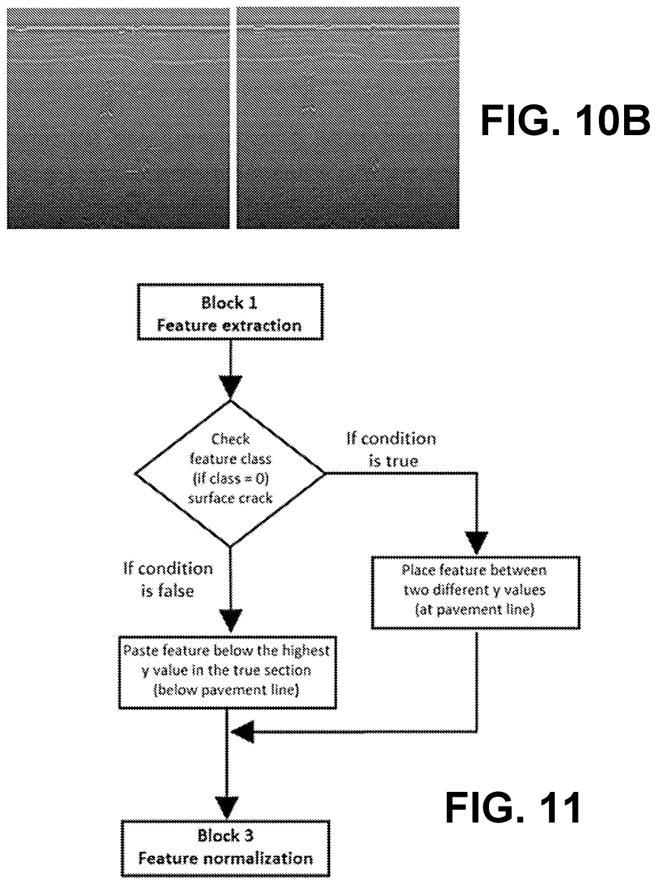

The construction of the synthetic GPR image dataset utilizes:
Backgrounds: For example, GPR objects free images used as the backdrop for which objects will be superimposed on the backgrounds shown in FIG. 10A.
Objects: Smaller features as in FIG. 8B can be placed on the backgrounds in different locations, that the model can detect.
Operations: A set of (optional) transformations can be applied to the training images including resizing, scaling, normalization, and placement.
   This process can create thousands of synthetic images such as those shown in FIG. 10B.

FIG. 11 illustrates an example of the object insertion location decision process for feature placement. Inserted features can be placed in what should be the correct places during the road scan, surface cracks can be placed at the pavement line where they are kept at this setting to replicate actual GPR scan data. On the other hand, for the other two features, the locations are only required to be below the pavement lines and within the first layer which can be proven by the condition that is implemented during the creation of the data.

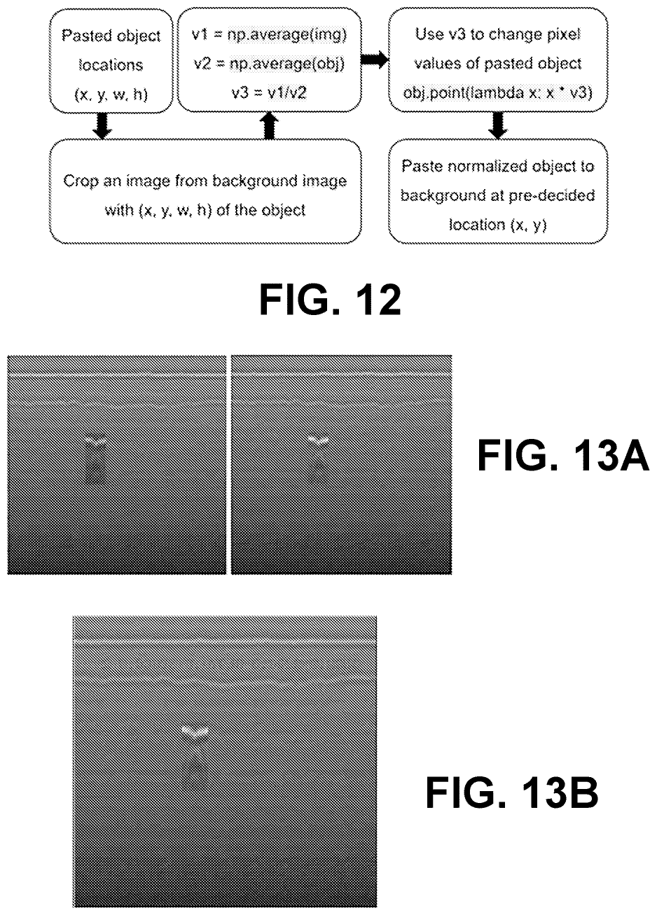

The process of normalizing inserted features can entail the generation of a synthetic dataset, the purpose of which is to generate experimental data that is near real in nature to enable effective training. FIG. 12 demonstrates the procedure to normalize the inserted objects. This is illustrated in FIG. 13A by showing the difference between the original object (left) and the normalized object (right).

Creating thousands of images for the training purposes may only represent 50% of the dataset creation. The created images are labeled in YOLO format to use this dataset for training. The images can be labeled manually, or creation of the synthetic images can automatically label the images. To create a complete dataset with labels, a small script can be added to the model to automate the workflow and the image annotation. FIG. 13B shows an example of the labeled image.

The model script can iterate through the backgrounds, objects, and pre-determined object sizes. It can create images with groups of icons to prepare the model for multiple real-world scenarios. For each background image, 650 separate groups of 3-6 icons can be randomly generated that are paired together. The script can also implement logic to ensure no icons overlap/intersect, no icons are out-of-bounds, and/or no objects are placed above pavement line.

### Results

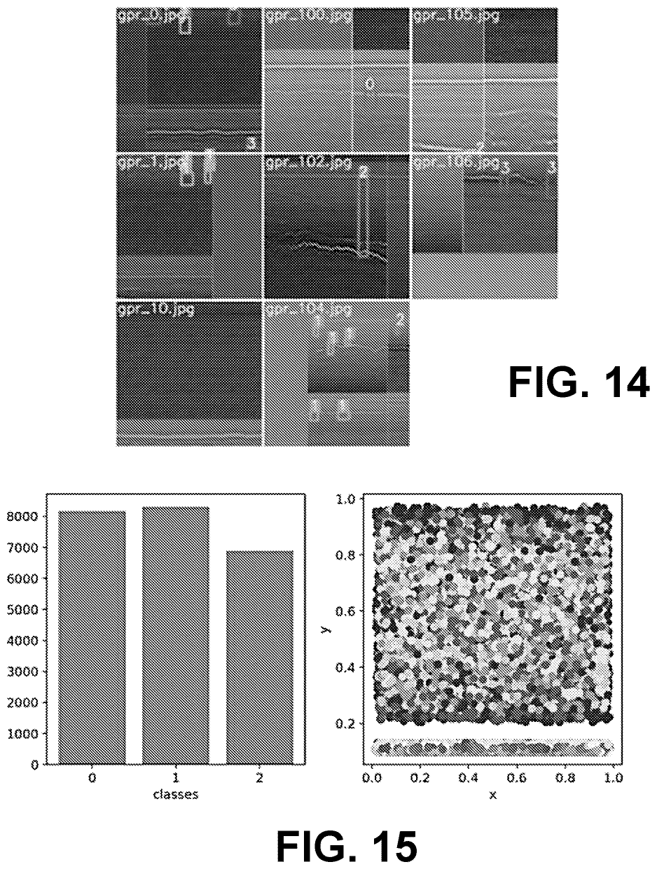

The detectors were based on Python 3.7, PyTorch 1.7, and the Darknet framework. All trials were performed using a google colab notebook with the following characteristics: Intel(R) Xeon(R) CPU @ 2.30 GHz, 13 GB memory, and NVIDIA Tesla K80 GPU. Train methods such as loss function and parameters related to learning were performed in the same way as in the existing YOLOR. For experimental data, real GPR images and synthetic datasets are used. FIG. 14 reveals an example of the YOLOR learning mosaic.

After explaining the characteristics and composition of each data set, the existing YOLOR can be examined to organize and analyze the results. To form the parameters, the same methods, and parameters of the existing YOLOR were applied. The pre-trained weights can be initialized by the weights of the model trained by the COCO dataset. In addition, the hyperparameters of the model are the batch size is set to 8 respectively; initial learning rate is 0.001; epoch is 50; others use default values.

For deep learning model, synthetic data was constructed for training purposes while real-world data is used for validation and testing. User signatures can be used to gather distinguishing features, and synthetic data can be used for training purposes. The completed data set was split in a ratio of 80%:20%, the number and location of crack classes after the image data is generated are shown in FIG. 15. Next, the actual GPR data is added to the validation/test dataset. For assessment, precision, recall, F1score and mAP are calculated. Accuracy and recall were calculated using equations (1) and (2). TP, FP, TN and FN mean true positive, false positive, true negative and false negative. The F1 score is calculated using equation (3).

Precision Score=TP/(FP+TP) (1)

Recall Score=TP/(FN+TP) (2)

F1 Score=2*Precision Score*Recall Score/(Precision Score+Recall Score) (3)

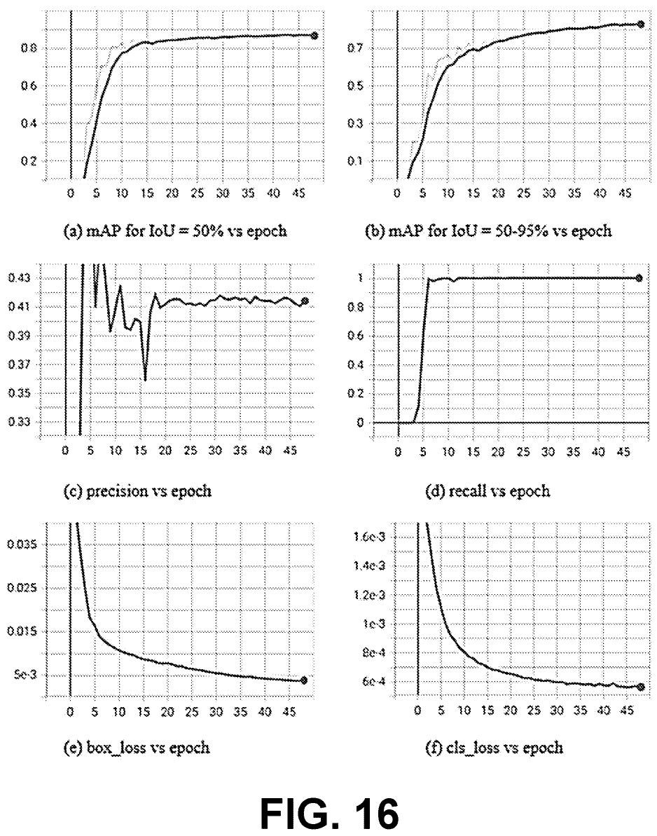

The used dataset consists of 5184 training images and 1296 validation images. The data included a total of 403,318 instances and had 3 classes, i.e., surface crack, bottom crack, and full crack. The existing train set was used as it was, and the validation set was randomly divided in half to make 648 for the validation set and the test set each. For training, the data were cropped by 320 pixels horizontally and vertically. The training results came as follows. Precession is 0.42, recall is 0.989, F1-score equal 0.58 with mAP (50%) of 0.845 and mAP (for 50%-95%) of 0.794. Those results are shown in FIG. 16.

Inference Results. Field GPR measurements have a higher level of noise and interference. Most of the time, the target is disturbances (cracks) in the ground, such as total cracks, surface cracks, and bottom cracks. To optimize efficiency and accuracy, the detection task is specifically designed for cracks of this nature. Detection of subsurface targets can be converted to detection of hyperbolic signatures in GPR configuration since subsurface targets are often reflected as hyperbolic signatures.

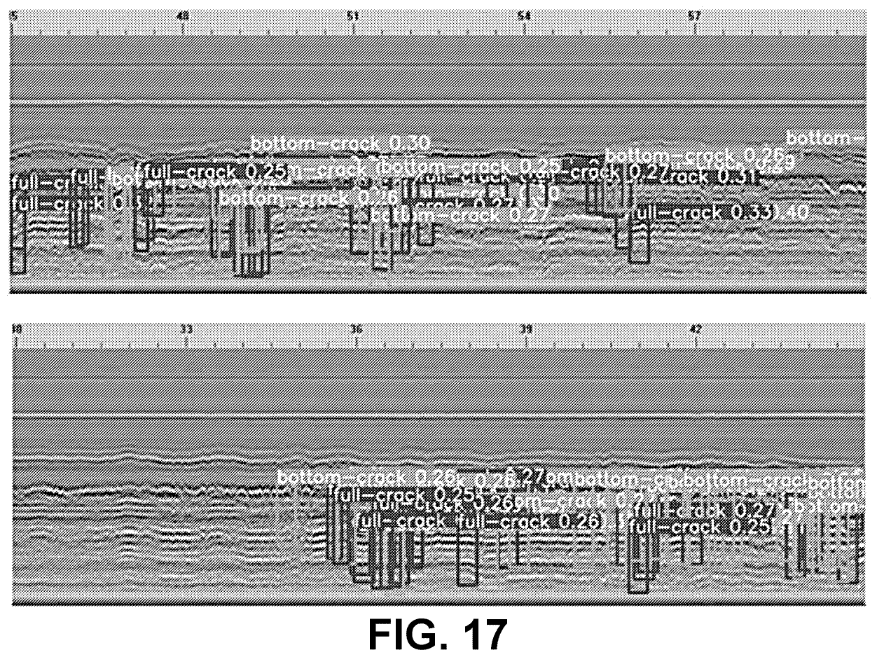

An example of recognition results for the cracks is given in FIG. 17. The GPR B-scan is shown in FIG. 17, in addition to several features distributed in the figure. Through the above experimental results, the state-of-art model of YOLOR trained using GPR synthetic dataset has achieved good results not only in detecting cracks in still images, but also in the real time application with different noise levels.

The improvement of loading condition for the service roads, materials, different types of infrastructures, and technology of pavement rehabilitation, led to the appearance of subsurface disturbances has the characteristics of different shapes and large changes in size. Vision-based detection of subsurface features is an issue in the intelligent monitoring of modern pavement rehabilitation processes. At present, the use of deep learning to detect subsurface cracks is mainly concentrated in several cases with few classes and quantities, and the accuracy is not high. Collecting enough reliable data can provide more possibilities for defect detection and automate road cracks categorization, for helping in Operation and Maintenance decision making.

The YOLO series, specifically modified the YOLOR model for subsurface crack detection, has been introduced. The dataset used for training is a synthetic data set, which can be created based on several acquired GPR profile images with different types of antennas. To expedite the detection of targeted objects, another actual GPR dataset can be added to the validation data set to increase the performance of model. This methodology can also be extended to pavement condition assessment utilizing satellite imagery.

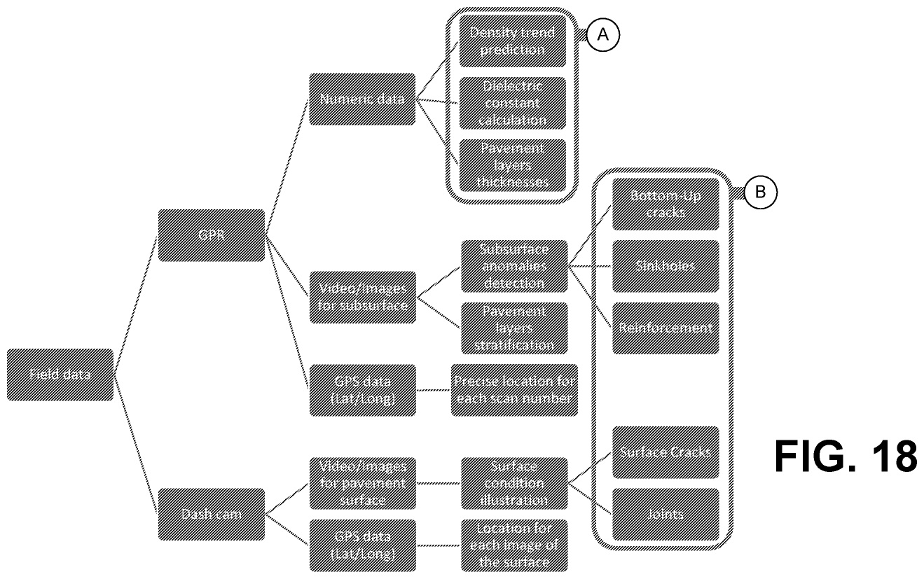

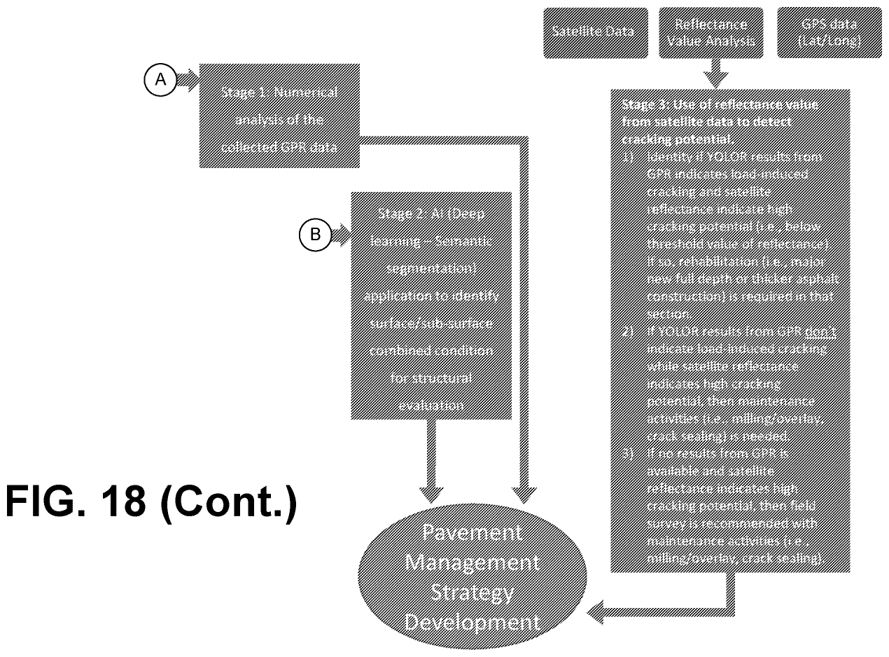

FIG. 18 illustrates an example of pavement management based upon a combination of remote satellite imagery analysis and surface detection. Field data such as, e.g., GPR and video/image data (e.g., from a dash cam) can be analyzed as illustrated. The field data can be evaluated using, e.g., numerical analysis and Al (e.g., deep learning) to identify pavement characteristics as illustrated. Satellite (or other remote) imagery can be evaluated using, e.g., reflectance analysis as illustrated. The analysis results can be utilized to determine a payment management strategy, which can be carried out to improve pavement conditions.

### Feature Generation Augmentation

The scarcity of target data (i.e., subsurface cracks) can also be dealt with two novel data augmentation methods, i.e., target feature insertion and generation, can be employed to generate a relatively large dataset for YOLOR model training. The YOLOR model can be trained to detect two classes of subsurface cracks: bottom cracks and full cracks. To leverage transfer learning, the network can be initialized with COCO-pretrained weights and finetuned with the GPR scan image dataset. The data acquisition and augmentation are presented describing feature insertion augmentation and variational auto-encoder (VAE) data insertion augmentation. The experiments and results are discussed, followed by conclusions.

Data acquisition and augmentation. GPR scan images were collected from various road sections in Atlanta and Athens, Georgia, using a test van, where the antennae were mounted at the back of the van. With over 400 miles of road scan, the obtained GPR image data are abundant. But the target features are scarce in the retrieved image data to successfully train the YOLOR model. To address this challenge, two augmentation methods are proposed. As previously discussed, the first method involves generating synthetic images by inserting target features into images without any target features. The second method uses the available featured images to generate new feature images. The resulting synthetic images are used for training the YOLOR model.

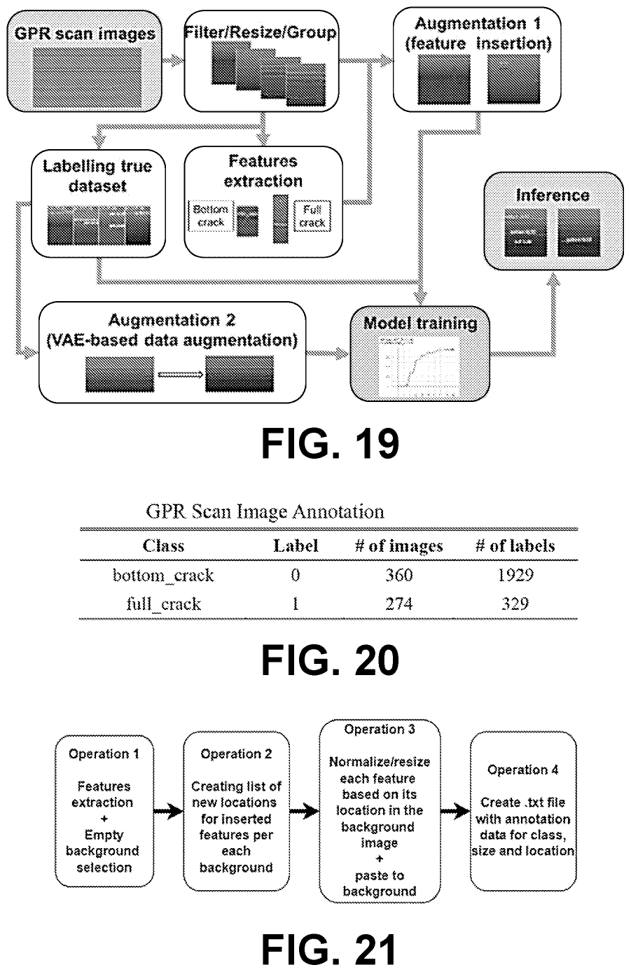

The process including a data pipeline, model training and inference is illustrated in FIG. 19. As shown in FIG. 19 the process begins with the GPR image acquisition from scanned road sections followed by the formation of the dataset for model training, which includes the use of the two augmentation methods for obtaining synthetic data. The YOLOR model training and testing can then be carried out and the trained model can then be used for the inference. The collected data can be divided into two groups: one with target features (referred to as featured images) and the other without target features (referred to unfeatured images). The images with target features can be manually labelled with respect to the format required by YOLOR training. The abundant unfeatured images can be used as background images for creating synthetic data by inserting extracted target feature patches (referred to as Augmentation 1 in FIG. 19), while the featured images can be used to generate new featured images (referred to as Augmentation 2 in FIG. 19).

GPR dataset. A total of 6,000 images were extracted from GPR scan recordings, followed by a screening process to extract 500 images with noticeable features, which were manually labelled. FIG. 8A shows examples of extracted images. As shown in FIG. 8A, irregularities in the GPR images have unique features and are indicative of internal cracks. The examples of enlarged feature patches representing two dominant crack types (e.g., bottom cracks and full cracks) are shown in FIG. 8B. These distinctive features in GPR scans indicate the presence of cracks in pavement inspired the use of deep learning-based object detection algorithms for their identification.

The detection of cracks in GPR images relies on the analysis of variations in electromagnetic wave propagation velocity across each pavement layer. The presence of cracks and voids in the pavement material results in inhomogeneity, which is revealed through a characteristic hyperbolic signature or reflection pattern in the GPR image. By examining the amplitude and frequency of the reflected electromagnetic wave, it is possible to estimate the dimensions of the crack, including its depth, length, and width. For proper detection of these target features, image cropping is needed so that the algorithm can focus on the region of interest, i.e., the pavement layers only. FIG. 8C shows an examples of both the raw image and the cropped image.

After the images are cropped to the region of interest, they are annotated with the target features. As a result, a total of 500 images were annotated and the captured target features are summarized in the table of FIG. 20. The labels presented in the table are based solely on the presence or absence of a bottom crack or a full crack and where they are located in each image. The images contain both types of cracks. While the utilization of online labeling tools enabled streamlining of the labeling process and improving efficiency, the manual labeling process was important in ensuring the accuracy of the dataset used for the study. Since the number of annotated images is quite limited for model training, synthetic data were generated to augment this labeled dataset for training the YOLOR model.

Data augmentation with feature insertion. In the context of object detection, an easy way to generate synthetic data with labels is through feature insertion. FIG. 21 illustrates an example of a process of generating synthetic data by feature insertion. Four sequential operations can be followed to generate synthetic images by feature insertion. FIG. 10A shows some examples of object-free images, which are used as backgrounds for superimposing target features. The target feature patches, as illustrated in FIG. 8B, are superimposed to the background images at proper locations. For generating realistic featured images, the locations of target features need to be below the asphalt layer line and they should not overlap with each other.

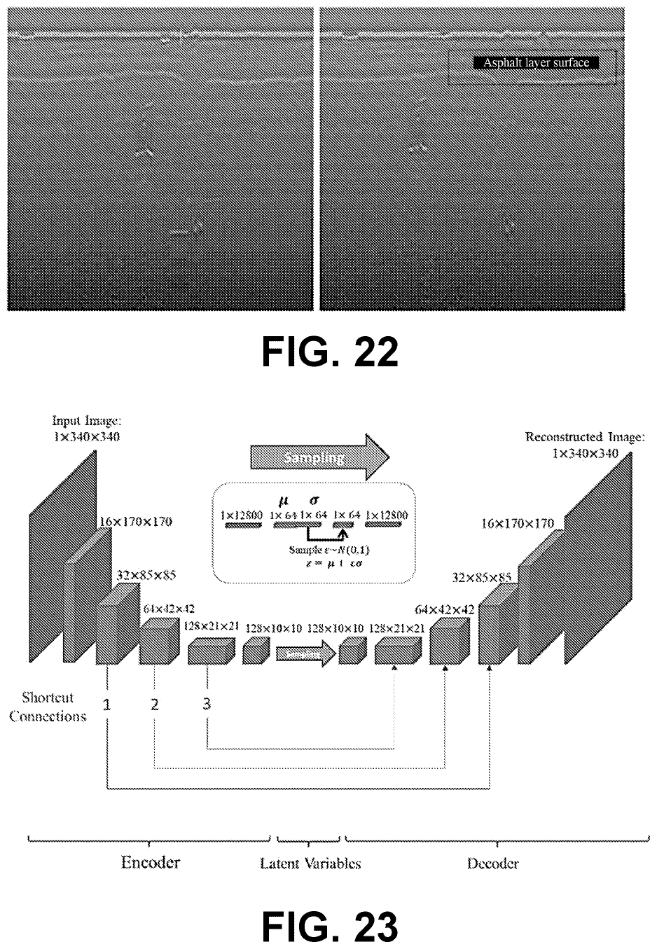

A series of transformations can be applied by considering the pixel values of the valid insertion locations to ensure realistic looking of the synthetic images. These transformations include resizing, scaling, normalization, and blending. Some exemplar synthetic images generated from this process are shown in FIG. 22. Since the inserted locations and feature types are known, the labels for these inserted features can be generated automatically, which greatly minimizes the annotation effort. However, depending on the insertion locations, the applied transformations may introduce some artifacts along the boundaries of inserted feature patches. Additionally, the resultant synthetic images may lack variation in target features. Due to these drawbacks, a Variational Auto-Encoders (VAE) based augmentation method can be employed to generate more natural looking featured images.

Data augmentation with generative models. An approach for dataset augmentation is to use generative models, such as Generative Adversarial Networks (GAN), and VAE. However, since there are not enough featured images to train a generative model at the first place, VAE was use with a compromised design that allows the low-level feature information to be utilized to generate new images. The adopted VAE architecture with shortcut connections is shown in FIG. 23. More sophisticated generative models, such as conditional GAN and StyleGANs, may also be used to generate realistic and diverse featured images to further the model performance.

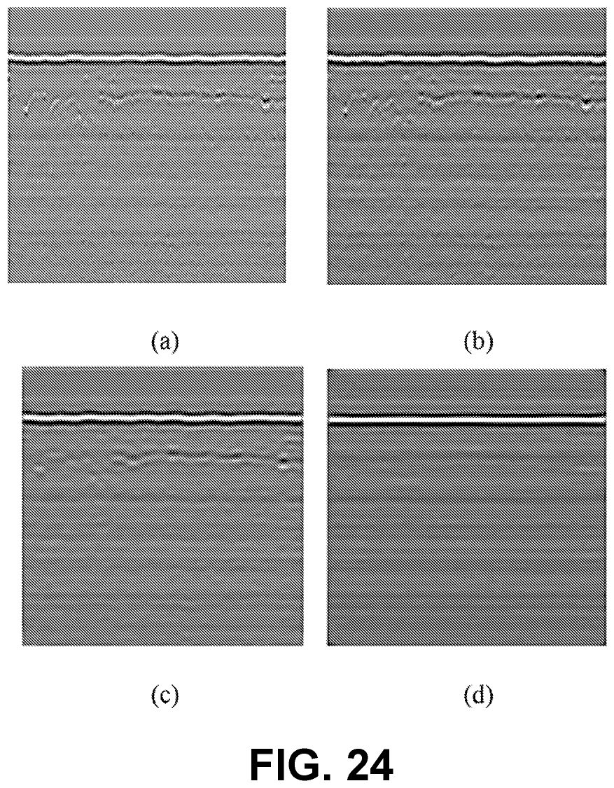

As shown in FIG. 23, corresponding feature blocks between the encoder and decoder are connected through shortcut connections. These shortcut connections help to pass the learned low-level target features to the decoder to generate fine-grained images. Because of the shortcut connections, the latent z (the bottleneck layer) only captures slimited information. As a result, the generated images are very similar to the input images with some textural differences. FIG. 24 shows examples of generated images by the VAE with different combinations of the skip connections. Comparison of the original image (a), generated image (b) with shortcut connections 1-3 in FIG. 23, and generated image (c) with shortcut connections 2 and 3 in FIG. 23, and generated image (d) out of shortcut connection 3. Although these VAE-generated images lack feature diversity, the experiment shows that the inclusion of such augmented data results in further improved performance of the model.

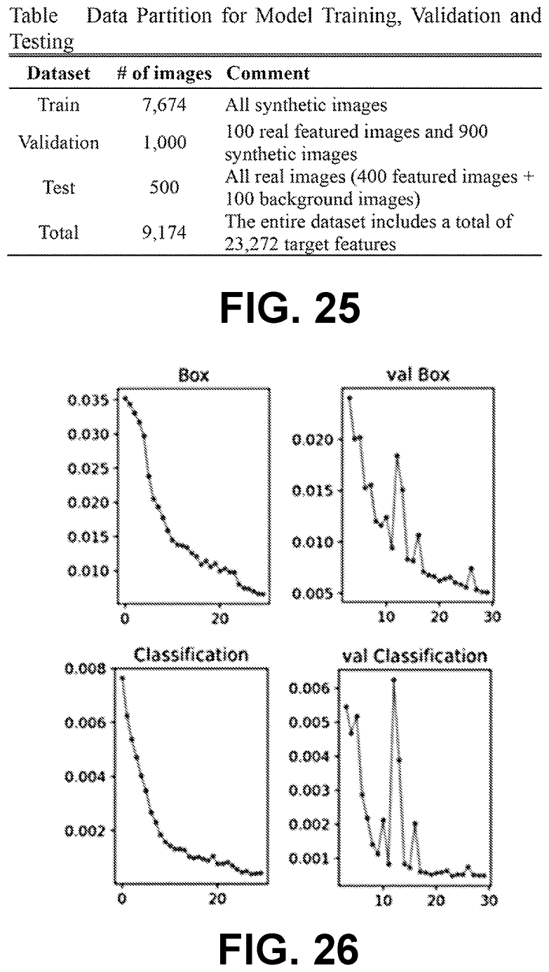

With both augmentation methods, a total of 9,174 GPR images was obtained. This dataset is partitioned for training, validation, and testing, as shown in the table of FIG. 25. It should be pointed out that the training dataset includes only synthetic images while the validation dataset has both synthetic and real images. The test dataset includes only real images.

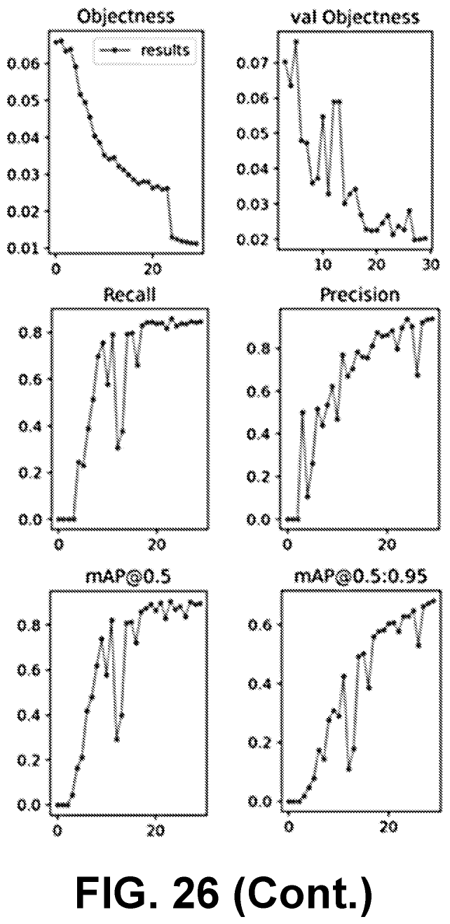

Experiments. The YOLOR-P6 model was adopted. Transfer learning was leveraged using pretrained weights with the COCO data. The model training was conducted using a workstation with Intel® Xeon® CPU@ 2.30 GHz, 13 GB RAM, and NVIDIA Tesla K80 GPU. The same YOLOR loss function was used. The classification head was modified to reflect two crack classes. Adam was used for training with a batch size of 8. The initial learning rate was set to 0.001. As the commonly adopted metric for objection detection, Average Precision (AP) at IOU=0.5 is reported. AP is computed based on the precision and recall curve. Precision and recall are defined by Eqs. (1) and (2). The training progress are depicted in FIG. 26. The training converges with a validation AP of 0.896.

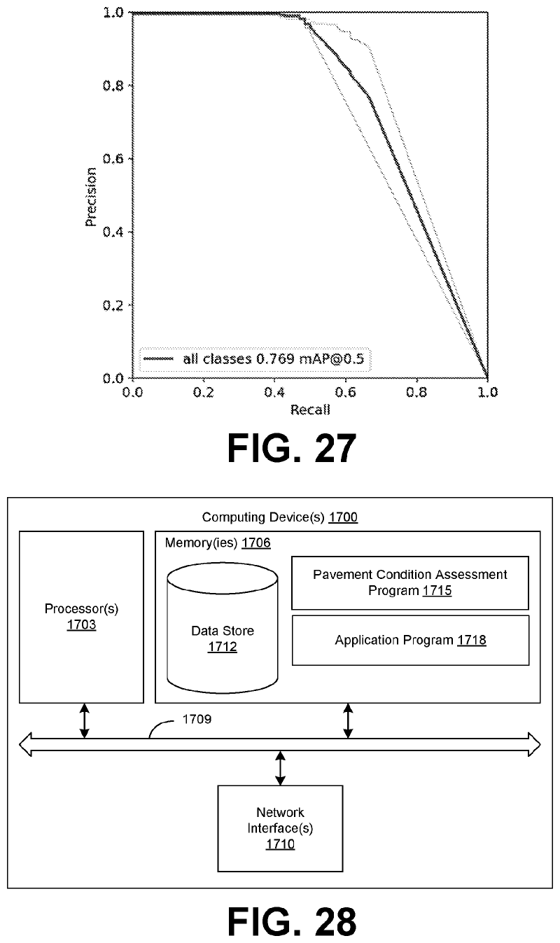

To truly evaluate the model performance, the test dataset, which contains only original featured images, is utilized. FIG. 27 shows the precision-recall curve from the test data. As a result, a similar performance is observed with the test data. The Aps@0.5 of 0.769, 0.803 and 0.735 are achieved for all cracks, bottom cracks, and full cracks, respectively.

Automated inspection of pavement subsurface conditions allows timely detection of potential structural issues (e.g., bottom-initiated cracks) and enables cost-effective repair and rehabilitation. A deep learning based real-time object detection model, YOLOR, was evaluated for detecting subsurface cracks in GPR scan images. The lack of quality target features for model training is an obstacle for deploying deep learning-based models.

Retrieved GPR scan data was preprocessed to filter out suspicious sections with target features. The filtered GPR scans were visually checked to verify the target features, followed by annotation. Due to the scarcity of target features, two data augmentation methods (i.e., feature insertion and generation) were implemented. The feature insertion method can quickly increase the dataset without a need for labeling. However, the features in the synthetic images lack variation. On the other hand, the generation method can use a VAE with shortcut connections. The generated images are basically reconstructed images that are very similar to the original images. Nonetheless, leveraging the augmented data from both methods for training can dramatically improve the model performance. The model achieved a test AP of 0.769 for detecting all crack features in the GPR scan images provided the training data contains only synthetic data. This result attests to the utility and feasibility of using the synthetic data for training quality deep learning models for detecting subsurface cracks.

System Implementation. With reference to FIG. 28, shown is a schematic block diagram of a computing device 1700 that can be utilized for predicting perfusion images from non-contrast scans. In some embodiments, among others, the computing device 1700 may represent a mobile device (e.g., a smartphone, tablet, computer, etc.). Each computing device 1700 includes at least one processor circuit, for example, having a processor 1703 and a memory 1706, both of which are coupled to a local interface 1709. To this end, each computing device 1700 may comprise, for example, at least one server computer or like device. The local interface 1709 may comprise, for example, a data bus with an accompanying address/control bus or other bus structure as can be appreciated.

In some embodiments, the computing device 1700 can include one or more network interfaces 1710. The network interface 1710 may comprise, for example, a wireless transmitter, a wireless transceiver, and a wireless receiver. As discussed above, the network interface 1710 can communicate to a remote computing device using a Bluetooth protocol. As one skilled in the art can appreciate, other wireless protocols may be used in the various embodiments of the present disclosure.

Stored in the memory 1706 are both data and several components that are executable by the processor 1703. In particular, stored in the memory 1706 and executable by the processor 1703 are a pavement condition assessment program 1715, application program 1718, and potentially other applications. Also stored in the memory 1706 may be a data store 1712 and other data. In addition, an operating system may be stored in the memory 1706 and executable by the processor 1703.

It is understood that there may be other applications that are stored in the memory 1706 and are executable by the processor 1703 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

A number of software components are stored in the memory 1706 and are executable by the processor 1703. In this respect, the term “executable” means a program file that is in a form that can ultimately be run by the processor 1703. Examples of executable programs may be, for example, a compiled program that can be translated into machine code in a format that can be loaded into a random access portion of the memory 1706 and run by the processor 1703, source code that may be expressed in proper format such as object code that is capable of being loaded into a random access portion of the memory 1706 and executed by the processor 1703, or source code that may be interpreted by another executable program to generate instructions in a random access portion of the memory 1706 to be executed by the processor 1703, etc. An executable program may be stored in any portion or component of the memory 1706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1706 is defined herein as including both volatile and nonvolatile memory and data storage components. Volatile components are those that do not retain data values upon loss of power. Nonvolatile components are those that retain data upon a loss of power. Thus, the memory 1706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1703 may represent multiple processors 1703 and/or multiple processor cores and the memory 1706 may represent multiple memories 1706 that operate in parallel processing circuits, respectively. In such a case, the local interface 1709 may be an appropriate network that facilitates communication between any two of the multiple processors 1703, between any processor 1703 and any of the memories 1706, or between any two of the memories 1706, etc. The local interface 1709 may comprise additional systems designed to coordinate this communication, including, for example, performing load balancing. The processor 1703 may be of electrical or of some other available construction.

Although the pavement condition assessment program 1715 and the application program 1718, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the pavement condition assessment program 1715 and the application program 1718, that comprises software or code can be embodied in any non-transitory computer-readable medium for use by or in connection with an instruction execution system such as, for example, a processor 1703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the pavement condition assessment program 1715 and the application program 1718, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 1700, or in multiple computing devices in the same computing environment. Additionally, it is understood that terms such as “application,” “service,” “system,” “engine,” “module,” and so on may be interchangeable and are not intended to be limiting.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A method, comprising:
obtaining satellite imagery including a portion of a roadway;
determining a reflective value corresponding to the portion of the roadway;
determining a pavement condition of the portion of the roadway based at least in part upon the reflective value; and
identifying a pavement management strategy based at least in part upon the pavement condition.

2. The method of claim 1, wherein the pavement condition is determined based upon pavement surface and subsurface conditions of the portion of the roadway.

3. The method of claim 2, wherein the pavement condition is determined by a machine learning model trained using measured and synthesized training data.

4. The method of claim 3, wherein the machine learning model is a YOLOR machine learning model.

5. The method of claim 3, wherein the synthesized training data is generated based upon the measured training data.

6. The method of claim 5, wherein the synthesized training data is generated from incorporation of a fault in measured training data.

7. The method of claim 2, wherein the pavement condition is determined by a machine learning model trained using synthesized and feature generated training data.

8. The method of claim 7, wherein the feature generated training data is generated using variational auto-encoder (VAE) based augmentation with shortcut connections.

9. The method of claim 1, wherein the pavement condition of the portion of the roadway is determined based at least in part upon a plurality of reflective values, each reflective value associated with a band of the satellite imagery.

10. The method of claim 1, wherein the pavement condition of the portion of the roadway is determined based comparison of the reflective value to a defined threshold and variation of the reflective value over a period of time.

11. A system, comprising:
a computing device comprising a processor and memory; and
an application for pavement condition assessment comprising machine readable instructions stored in the memory that, when executed by the processor, cause the computing device to at least:
obtain satellite imagery including a portion of a roadway;
determine a reflective value corresponding to the portion of the roadway;
determine a pavement condition of the portion of the roadway based at least in part upon the reflective value; and
identify a pavement management strategy based at least in part upon the pavement condition.

12. The system of claim 11, wherein the pavement condition is determined based upon pavement surface and subsurface conditions of the portion of the roadway.

13. The system of claim 12, wherein the pavement condition is determined by a machine learning model trained using measured and synthesized training data.

14. The system of claim 13, wherein the machine learning model is a YOLOR machine learning model.

15. The system of claim 13, wherein the synthesized training data is generated based upon the measured training data.

16. The method of claim 15, wherein the synthesized training data is generated from incorporation of a fault in measured training data.

17. The system of claim 12, wherein the pavement condition is determined by a machine learning model trained using synthesized and feature generated training data.

18. The system of claim 17, wherein the feature generated training data is generated using variational auto-encoder (VAE) based augmentation with shortcut connections.

19. The system of claim 11, wherein the pavement condition of the portion of the roadway is determined based at least in part upon a plurality of reflective values, each reflective value associated with a band of the satellite imagery.

20. The method of claim 11, wherein the pavement condition of the portion of the roadway is determined based comparison of the reflective value to a defined threshold and variation of the reflective value over a period of time.
